(19) United States
(12) Patent Application Publication
(10) Pub. No.: US 2010/0259937 A1
(43) Pub. Date: Oct. 14, 2010

(54) Candle Lighting Type Reflective Lampshade

(75) Inventors: Ming-Chang WU, Tucheng City (TW); Chih-Chun Wen, Tucheng City (TW); Chih-Hung Wei, Tucheng City (TW)

Correspondence Address: FRENKEL & ASSOCIATES, 3975 UNIVERSITY DR., STE. 330, FAIRFAX, VA, 22030, US

(73) Assignee: High Power Lighting Corp., Tucheng City (TW)

(21) Appl. No.: 12/420,431

(22) Filed: Apr. 8, 2009

(51) Int. Cl. F21V 7/00; F21S 6/00; F21V 3/00

(52) U.S. Cl. 362/296.01; 362/257; 362/311.01; 362/311.02

(57) ABSTRACT

A candle lighting type reflective lampshade comprises a lampshade main body being made with a reverse cone body on the upper half thereof and a cover layer on the inner cone surface thereof, wherein the cone surface forming a pair of symmetrical parabolic curves includes a ring type aperture on the top thereof thereby allowing the underside light source to achieve secondary full reflection; the base of lampshade main body comprises a plurality of inclined surfaces being ringly peripherally installed thereon and being installed with a plurality of lamp source bases below the inclined surfaces, while the light source is effectively controlled by the lamp source base to beam the light on the cone top portion of the reverse cone body so as to fully reflect each light beam and to achieve uniform dispersion of the light source.

### FIELD OF THE INVENTION

The invention is related to lampshade, more particularly to a candle lighting type reflective lampshade.

### BACKGROUND OF THE INVENTION

FIG. 1 is the conventional art of the conventional lampshades commonly sold on the market. As shown in the figure, it is a lamp set 1 comprising a base 11 being matchingly installed with a light source 12; a lampshade 2 being an end-shade is installed on base 11 of lamp set 1 and internally axially formed with a cone surface 22 relative to the end face 21 of lamp set 1 for dustproof, waterproof and protection of light source 12 on lamp set 1, wherein the cone surface 22 is constituted by a circular cone shaped structure with a V type axial section. In addition, the lampshade 2 is further peripherally made with a cover layer 3 on the outer edge of end face 21 of the cone surface 22 thereof, wherein light beams of the lamp set 1 can be absorbed by the cover layer 3 if it is made of light-absorbing material.

The aforesaid conventional art has the following imperfections: the light source 12 on lamp set 1 can emit lights to all directions, but the light reaching the end face 21 of lampshade 2 relative to light source 12 is not effectively fully reflected by the cone surface 22 due to insufficient focusing by light source 12. As a result, when it is applied in relevant products of lamp decorations, brightness of the whole lamp set 1 is affected thereby wasting the efficiency of light source 12, and that is a big disadvantage of the conventional art in the modern times of saving, simplicity and environmental protection demands for everything.

In view of the aforesaid imperfections of conventional arts, the invention therefore discloses a candle lighting type reflective lampshade aiming to solve the existing imperfections of conventional arts.

### SUMMARY OF THE INVENTION

The main purpose of the invention is to disclose a candle lighting type reflective lampshade, wherein a plurality of light sources being installed on the inclined surfaces are ringly peripherally installed on the bottom of lampshade main body thereby allowing the light sources to focus on the inclined surfaces so as to achieve the target of uniform dispersion thereby fully utilizing the light sources to achieve the purpose of promoting the light source reflecting efficiency.

The another purpose of the invention to disclose a candle lighting type reflective lampshade which is internally installed with various filling mediums good for refraction such as air, neon gas, etc. thereby achieving the target of easy transmission.

To achieve the above said purpose, the invention discloses a lampshade, more particularly a candle lighting type reflective lampshade which comprises a lampshade main body being made with a reverse cone shaped body on the upper half thereof and is made with a cover layer on the inner cone surface thereof, wherein the cone surface form a pair of symmetrical parabolic curves and further includes a ring type aperture on the top thereof thereby allowing the underside light source to achieve the purpose of secondary full reflection through the aperture. The base of lampshade main body comprises a plurality of inclined surfaces being ringly peripherally installed thereon and is installed with a plurality of lamp source bases below the inclined surfaces, and a light source being enclosed within the lamp source base is effectively controlled by the lamp source base to beam the light on the cone top portion of the reverse cone body so as to fully reflect each light beam through the spot lighting effect of the lamp source base thereby achieving the target of uniform dispersion of the light source, wherein the lampshade main body can be applied in various pendant lamp decorations and is very suitable for industrial mass productions.

The purpose, technical contents, characteristics and achieved effectiveness of the invention are described in detail by the specific embodiments and the accompanied figures in the following.

### BRIEF DESCRIPTION OF THE DRAWINGS

FIG. 1 shows the conventional art.

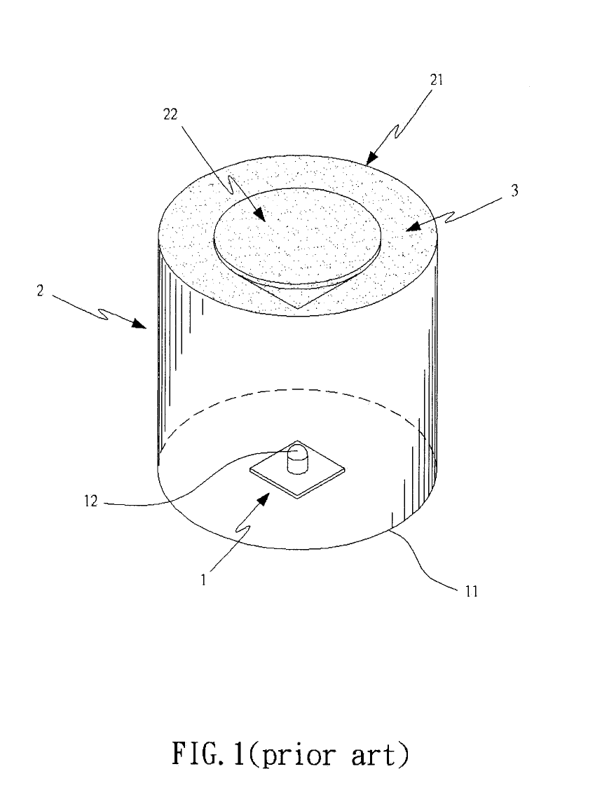

FIG. 2 is a perspective view of the candle lighting type reflective lampshade of the invention.

FIG. 3 is a side view of the candle lighting type reflective lampshade of the invention.

FIG. 4 is a sectional perspective view of the candle lighting type reflective lampshade of the invention.

FIG. 5 is another embodiment of the candle lighting type reflective lampshade of the invention.

### DETAIL DESCRIPTION OF THE PREFERRED EMBODIMENTS

For the convenience of examiners to succinctly understand the other features and advantages of the invention as well as to further reveal its achieved effectiveness, the invention is described in detail with the accompanied figures in the following:

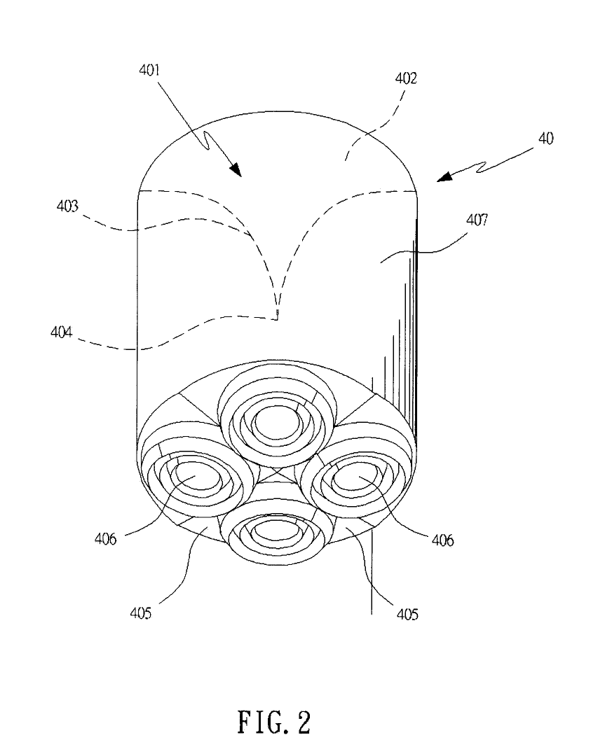

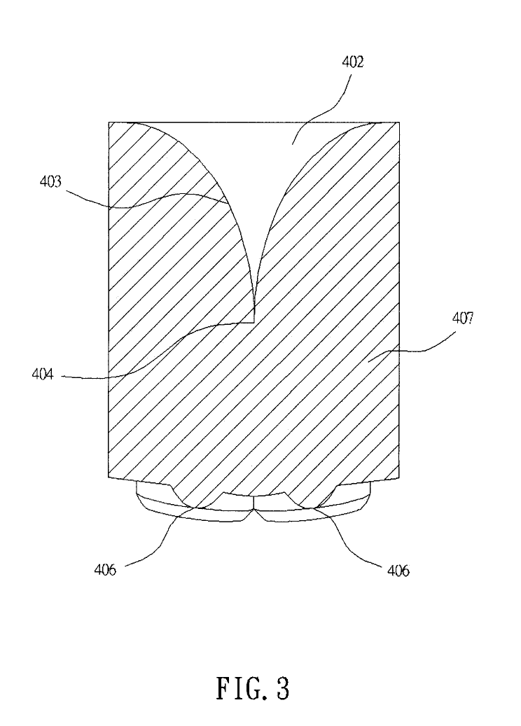

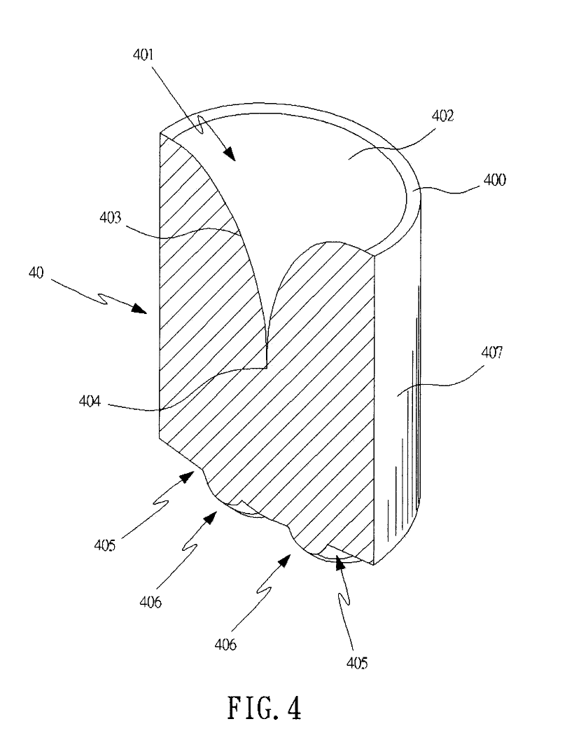

FIG. 2 is a perspective view of the candle lighting type reflective lampshade of the invention. FIG. 3 is a side view of the candle lighting type reflective lampshade of the invention. FIG. 4 is a sectional perspective view of the candle lighting type reflective lampshade of the invention. As shown in the figure, a lampshade main body 40 is made with a reverse cone body 401 on the upper half thereof and is made with a cover layer 402 on the inner cone surface 403 thereof thereby making the cone surface 403 form a pair of symmetrical parabolic curves to further form a cone top 404; further, top of the lampshade main body 40 includes a ring type aperture 400 to allow the underside light source to pass through it so as to achieve the purpose of secondary total reflection, wherein the cover layer 402 can be made of reflective or translucent material, and the cone surface 403 of reverse cone body 401 can be constituted by symmetrical flat surfaces, concave or convex type curved surfaces so as to achieve the purpose of allowing the light source to be uniformly reflected.

The base of lampshade main body 40 is ringly installed with a plurality of inclined surfaces 405 thereon, and the inclined surface 405 is installed with a plurality of lamp source bases 406 mainly for enclosing fixed light sources to be matched with the inclined surfaces 405 to produce a spot light effect, wherein the lamp source bases 406 and the light sources are commonly ringly peripherally installed on the bottom of the lampshade main body 40 to effectively control the light from the light source to beam on the cone top 404 portion of the reverse cone body 401, wherein the top cone 404 forms an equivalent light source emission focusing point to achieve the purpose of uniform dispersion. Furthermore, the light source can be either constituted by light emitting diodes(LED) or conventional light bulbs without limiting the illumination methods, and the lamp source base can be adopted with a Fresnel lens surface with spot light effect to further achieve the linear emitting light source effect in order to beam the light source more directly on the portion of cone top 404. The lampshade main body 40 has a lampshade 407 being constituted by a flat surface or a circular type convex or concave type curved surface, wherein the lampshade 407 is internally installed with various filling mediums good for refraction such as air, neon gas, etc. thereby achieving the target of easy transmission and full reflection of each light beam as well as achieving the target of uniform dispersion of the light source, wherein the lampshade main body 40 can be applied in various pendant lamp decorations and is very suitable for industrial mass productions.

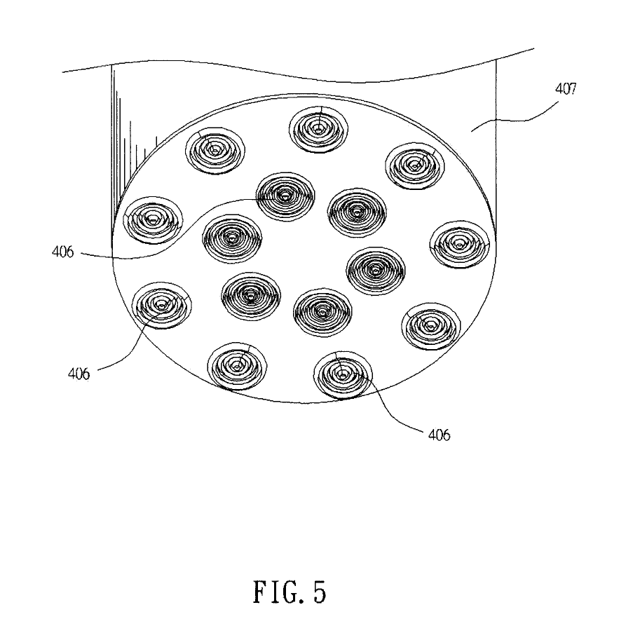

FIG. 5 is another embodiment of the candle lighting type reflective lampshade of the invention; as shown in the figure, the lamp source base 406 can be adopted with a multi-point light source design to allow a plurality of units to line up orderly on the base of lampshade main body 40 thereby enhancing illumination of the light source and promoting the integral brightness of the lampshade main body 40.

As summarized from above descriptions, the invention has been achieving the intended improved effectiveness by breaking through the structure limitation of prior arts and has been beyond the thought of those who are skilled in the arts; further, the progressiveness and practical usefulness of the invention are unpublicized before the patent application that are clearly conforming to the conditions of patent application, therefore it is applied for patent according to the law herein, and your esteemed bureau's approval on the application to encourage future more inventions will be greatly appreciated.

The above said embodiments merely described the technical thought and characteristics of the invention that is mainly purposed to allow those skilled in the arts to familiarize with the content of the invention and to execute accordingly, and is not limiting the patent scope of the invention; hence, all equivalent changes or modifications based on the disclosed spirits of the invention shall still be covered in the claims of the invention.

What is claimed is:

1. A candle lighting type reflective lampshade comprises at least the following:
A lampshade main body is made with a reverse cone body on the upper half thereof and is made with a cover layer on the inner cone surface thereof, thereby making the cone surface form a pair of symmetrical parabolic curves.
The lampshade main body is made with a plurality of inclined surfaces on the bade thereof, and the inclined surface is installed with a plurality of lamp source bases on the underside thereof; and
A light source being enclosed within the lamp source base is effectively controlled by the lamp source base to beam the light on the cone top portion of the reverse cone body through the spot lighting effect of the lamp source base.

2. The candle lighting type reflective lampshade as claimed in claim 1, wherein the cone surface of the reverse cone body can be a flat surface.

3. The candle lighting type reflective lampshade as claimed in claim 1, wherein the cone surface of the reverse cone body can be a convex or concave type curved surface.

4. The candle lighting type reflective lampshade as claimed in claim 1, wherein the cover layer can be made of reflective or translucent material.

5. The candle lighting type reflective lampshade as claimed in claim 1, wherein the lamp source base and light source are ringly installed on the bottom of lampshade main body.

6. The candle lighting type reflective lampshade as claimed in claim 1, wherein the lampshade can be a flat surface, or a convex or concave type curved surface.

7. The candle lighting type reflective lampshade as claimed in claim 1, wherein cone top is a focusing point on the cone surface.

8. The candle lighting type reflective lampshade as claimed in claim 1, wherein the light source can be constitute by light emitting diodes (LED) or conventional light bulbs.

9. The candle lighting type reflective lampshade as claimed in claim 1, wherein top of the lampshade main body further includes a ring type aperture to allow the underside light source to pass through it so as to achieve the purpose of secondary total reflection.
